(19) United States
(12) Patent Application Publication
(10) Pub. No.: US 2006/0235097 A1
(43) Pub. Date: Oct. 19, 2006

(54) PERMEABLE FOAM

(76) Inventors: Debra-Jean F. Mahoney, Methuen, MA (US); Marguerite Livermore, Salem, NH (US); Fredrick Mellish, Lowell, MA (US); Jeffrey Heil, Nashua, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/279,833

(22) Filed: Apr. 14, 2006

Related U.S. Application Data
(60) Provisional application No. 60/671,038, filed on Apr. 14, 2005.

(51) Int. Cl. C08J 9/26

(52) U.S. Cl. 521/61

(57) ABSTRACT

The present invention relates to permeable closed cell foam. The foam may be produced by forming a substrate including a polymeric material, a foaming agent and optionally a crosslinking agent. Holes may be formed in the substrate and the substrate may be crosslinked. The foaming agent may then be activated to expand the foam. The closed cells may be present at a level of greater than about 50% in a given portion of any foam.

### CROSS REFERENCE TO RELATED APPLICATIONS

The present application claims the benefit of U.S. Provisional Application No. 60/671,038, filed on Apr. 14, 2005.

### FIELD OF INVENTION

The present invention relates to permeable substantially closed cell foam and a method for producing such foam.

### BACKGROUND

Foam is a general reference to a material having a cellular structure. The structure may be the result of the introduction of gas bubbles into a polymer matrix through mechanical and/or chemical processes. The cellular structure of foam may be characterized as open cell or closed cell. In an open-cell structure, the cells may be interconnected, wherein openings exist in the cell walls. Open cell foam may be permeable in nature; for example, gas may move within and through out the cellular structure. In closed cell structures, the cells may be separate and discrete, having little or no holes or openings in the walls and may be relatively impermeable in nature.

### SUMMARY

A first exemplary embodiment of the present invention relates to permeable foam comprising crosslinked foam utilizing an expanded substrate wherein the expanded substrate includes a closed cell structure. The closed cells may be present at a level of greater than about 50% wherein the crosslinked foam may also be made permeable. The permeability may be due to a plurality of voids. The voids may be further characterized as having been formed in the foam prior to foam formation, i.e., expanding the substrate.

A second exemplary embodiment includes a method for producing permeable and substantially closed cell foam which may include forming a substrate including a polymer material and a foaming agent. The substrate may be crosslinked and holes may be formed in the substrate. The foaming agent may then be activated to expand the substrate.

### BRIEF DESCRIPTION OF DRAWINGS

The detailed description below may be better understood with reference to the accompanying figures which are provided for illustrative purposes and are not to be considered as limiting any aspect of the invention.

FIG. 1 is a schematic of an exemplary method for producing permeable closed cell foam.

### DETAILED DESCRIPTION

The present invention relates to permeable, substantially closed cell foam, and a method for producing such foam. Closed cell foam may be understood as a foam wherein at least 50% of the cells are enclosed and do not connect with other cells for a given cross-sectional dimension of a given sample of foam material. The permeable closed cell foam may include a polymer composition incorporating a foaming agent. The polymer composition may be formed into a substrate which may then be crosslinked and perforated, in any order. The foaming agent may then be activated to expand the substrate and produce permeable closed cell foam.

The polymer composition includes polymer materials such as thermoplastics, thermoplastic elastomers, rubber, etc. Exemplary materials may include polyolefins which may be understood to be any polymer based upon the polymerization or copolymerization of ethylene or a substituted ethylene monomer, wherein the substitution comprises carbon-hydrogen functionality. This may therefore include polymers such as polyethylene or polypropylene, ethylene vinyl acetate, copolymers and blends thereof. The foam may also include polyurethane, urea-formaldehyde resin, silicones, etc. However, these examples are not limiting. Any polymer material that may be crosslinked and expanded by a foaming agent may be incorporated herein.

The polymer composition may also optionally incorporate a crosslinking promoter. Crosslinking promoters may include chemical or radiation crosslinking promoters. Exemplary crosslinking promoters may include organic peroxides, trimethylol propane triacrylate, trimethylol propane trimethacrylate, tetramethylol tetraacrylate, trimethylol propane trimellitate, triallyl isocyanurate, triallyl cyanurate, triallyl trimellitate, tetraallyl pyromellitate, pentaerythritol trimethacrylate, tri (2-acryloxyethyl) isocyanurate, tri (2-methacryloxyethyl) trimellitate, etc. The crosslinking promoter may be present in the range of 0.001% to 25% by weight of the polymer composition, including all values and increments therebetween. Other additives may also be incorporated into the polymer composition including flame retardants, antimicrobials, colorants, etc.

The foaming agent incorporated in the polymer composition may include any inorganic or organic substance used in polymeric materials to produce a foam structure. A foaming agent may be a substance that exhibits chemical activity at a specific temperature, i.e. the activation temperature, wherein at least one of the resulting products of such activity may be a gas. Activation temperatures may range between 100° C. to 300° C., including all values and increments therein, such as between 150-165° C., 215° C., etc. The foaming agent may be present in the range of 0.001 to 25% by weight of the polymer composition, including all values and increments therebetween. The foaming agent may be a liquid or powder having a relatively small particle size.

The foaming agent may include azo compounds, hydrazine derivatives, semicarbazides, tetrazoles, benzoxazines, etc. Azo compounds may include for example azodicarbonamide and modifications thereof. Hydrazine derivatives may include 4,4′-oxybis(benzenesulfohydrazide), diphenylsulfone-3,3′-disulfohydrazide, diphenylene oxide-4,4′-disulfohydrazide, trihydrazinotriazine, etc. Semicarbazides may include p-Toluenesulfonyl semicarbazide, tetrazoles may include 5-phenyltetrazole and benzoxazines may include isatoic anhydride.

The polymer composition, including a polymer material, foaming agent and optionally a crosslink promoter, may be blended via dry or melt blending. Dry blending is a general reference to blending by mechanical action without causing the polymer material to flow. Dry blending may occur in a mixing device, such as a mixer or tumbler. Melt blending or mixing is a general reference to blending in which the polymer material is caused to flow. Melt blending may occur in an extruder barrel, such as a single or twin screw extruder.

The polymer composition may then be formed into a substrate. The substrate may be formed by any method of melt processing, wherein the polymer composition is caused to flow due to exposure to thermal and/or mechanical energy. An exemplary form of melt processing includes extrusion. It should be appreciated however, that processing temperatures during melt processing should remain below the activation temperature of the foaming agent. It should also be appreciated that the steps of melt blending and substrate formation may be combined. For example, during melt processing, the various components, i.e. polymer material, foaming agent and optionally the crosslinking promoter, may be melt blended as well. The substrate may be formed into any desired shape, including sheet or film. The substrate may have a thickness in, for example, the range of 0.001 to 1.00 inch, including all values and increments therein. Once formed, the substrate may be perforated and then crosslinked or the substrate may be crosslinked and then perforated.

Perforation of the substrate may be performed to form holes in the substrate using any known mechanism in the art such as die cutting, drilling, laser cutting, water jet cutting, etc. It should be appreciated however that the processing temperature during perforation should also remain below the activation temperature of the foaming agent to prevent premature expansion of the substrate. The size of the perforations or holes may be greater than 0.001 mm, including in the range of 0.001 to 100 mm, including all values and increments therein. The holes may be circular or any number of geometries, such as oblong, square, triangular, rectangular, letters, numbers, symbols, characters, etc. The holes as cut may also vary in geometry after the substrate has been expanded due to differential volumetric expansion. Accordingly, proper sizing of the holes may be necessary according to the predicted expansion of the substrate in the machine and cross-direction when the foaming agent is activated. The machine direction may be understood as a direction parallel to polymer flow, wherein cross-machine direction may be understood as a direction perpendicular to polymer flow.

Crosslinking of the substrate may be performed chemically or via irradiation. Irradiation or electron beam radiation may be understood as a process in which the polymer composition is bombarded with high-energy electrons. During irradiation, active sites may develop along the polymer chains of the polymer material which may bond to other active sites on other polymer chains causing the chains to crosslink. Process variables that may be adjusted during irradiation include the amount of power or voltage and the duration of exposure.

Once perforated and crosslinked the foaming agent may then be activated to release gas. Activation may occur by exposure of the substrate to thermal energy and raising the temperature of the foaming agent to its activation temperature. Thermal energy may be supplied via convection, conduction or radiation. In exemplary embodiments the foaming agent may be activated in an oven or by exposure to infrared radiation.

The expanded substrate may have a thickness above 0.005 inches, including in the range of 0.005 inches to 10 inches in thickness, including all values and increments therebetween. In addition, the expanded substrate may also have a density of in the range of about 1.0 to 50.0 lbs/ft³, including all values and increments therein.

The perforation density of the expanded substrate may be in the range of 1 hole per square foot to 10,000 holes per square foot, including all values and increments therein, such as 10 holes per square foot, 100 holes per square foot, etc. The volume expansion ratio of the perforations (V₂/V₁) may be between 1.01 to 10000, wherein V₁ is the initial volume of a perforation and V₂ is the volume of the perforations after expansion. Expansion may be either isotropic or anisotropic. In addition, the resulting expanded substrate may have a void fraction of between about 0.01 to 90% including all values and increments therein, such as 1%, 10%, etc. Void fraction being a reference to the amount of void space or volume created by the perforations.

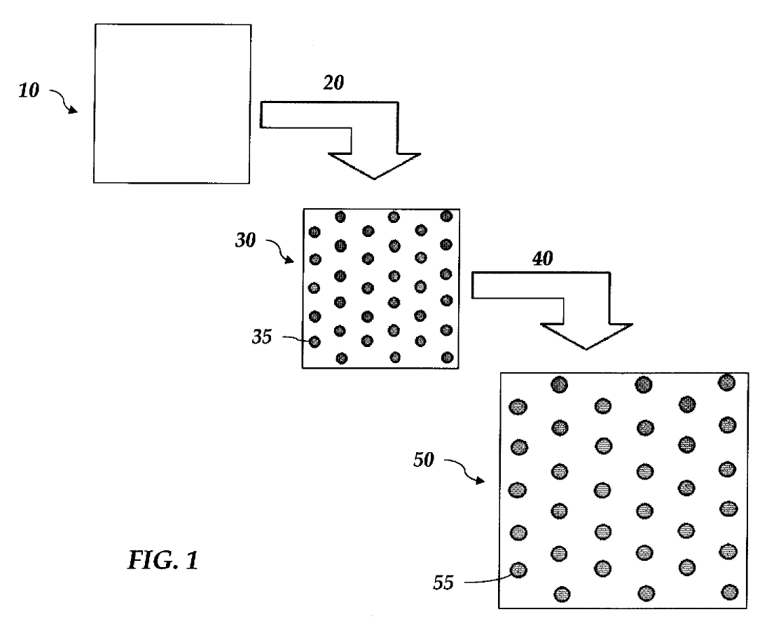

Accordingly, illustrated in FIG. 1 is a schematic of an exemplary method for forming permeable closed cell foam as well as an illustration of exemplary products formed during the execution of the method. Again, as noted above, the proportion of closed cell foam may include foam where about 50% of the cells are closed and do not connect with other cells, as well as foam containing 50% - 100% closed cell structure, including all value and increments therein. For example, the foam herein may include a material wherein about 70-90% of the cells are closed cell.

A polymer composition may be formed into a sheet 10. Once formed, the substrate may be crosslinked and perforated 20 and the resulting sheet 30 may therefore include a number of holes or perforations 35. Once crosslinked and perforated, the sheet may be expanded 40 to form an expanded substrate 50 including a number of expanded perforations 55. As alluded to above, crosslinking and perforation may occur in any order. In addition, the degree of crosslinking may be controlled to provide foam with varying mechanical properties. For example, the foam may be relatively soft to semi-rigid and may have a Shore A hardness in the range of about 0 to 100, including all values and increments therein, such as a hardness in the range of 0 to 60, a hardness of about 50, etc. The foam may also have a Shore OO hardness in the range of about 20 to 100, including all values or increments therein, such as a hardness in the range of 30 to 40, a hardness of about 60, etc.

The foregoing description is provided to illustrate and explain the present invention. However, the description hereinabove should not be considered to limit the scope of the invention set forth in the claims appended here to.

What is claimed is:

1. A method for producing permeable closed cell foam comprising:
forming a substrate including a polymer material and a foaming agent;
crosslinking said substrate;
forming holes in said substrate; and
activating said foaming agent to expand said substrate.

2. The method of claim 1 wherein said step of crosslinking occurs before said step of forming holes in said substrate.

3. The method of claim 1 wherein said step of forming holes occurs before said step of crosslinking.

4. The method of claim 1 wherein said step of crosslinking comprises irradiating said substrate.

5. The method of claim 1 wherein said step of activating said foaming agent comprises thermally activating said foaming agent.

6. The method of claim 1 wherein said substrate also includes a crosslinking promoter.

7. The method of claim 1 wherein said polymer material comprises a polyolefin.

8. The method of claim 1 wherein said polymer material comprises ethylene vinyl acetate.

9. The method of claim 1 wherein said foaming agent comprises an azo compound or a modified azo compound.

10. The method of claim 1 wherein said foaming agent has an activation temperature in the range of about 100 to 300° C.

11. The method of claim 10 wherein said step of forming said substrate occurs at a process temperature below said activation temperature.

12. The method of claim 10 wherein said step of forming holes in said substrate occurs at a process temperature below said activation temperature.

13. The method of claim 1 wherein said substrate, prior to activation, comprises a sheet having a thickness of between 0.001 inches to 1.00 inches.

14. The method of claim 1 wherein said expanded substrate comprises a sheet having a thickness of in the range of about 0.005 inches to 10 inches.

15. The method of claim 1 wherein said holes before said step of activating have a first volume V₁ and after said step of activating have a second volume V₂, wherein V₂>vi.

16. The method of claim 15 wherein the ratio of V₂,V₁ is in the range of about 0.01 to 10000.

17. The method of claim 1 wherein said expanded substrate has a void fraction in the range of between 0.01 to 90%.

18. The method of claim 1 wherein said expanded substrate has a perforation density in the range of about 1 hole per square foot to 10,000 holes per square foot.

19. The method of claim 1 wherein said foam has at least about 50% closed cells.

20. A permeable foam comprising:
a crosslinked foam comprising an expanded substrate wherein said expanded substrate includes closed cells;
said closed cells are present at a level of greater than about 50% wherein said crosslinked foam is permeable; and
wherein said permeability comprises a plurality of voids, said voids characterized as having been formed in said foam prior to expanding said substrate and forming said foam.
